(19) United States
(12) Patent Application Publication
(10) Pub. No.: US 2026/0165297 A1
(43) Pub. Date: Jun. 18, 2026

(54) Reusable and Disposable Canine Paw Traction Enhanced Canine Paw Covers

(71) Applicant: Susan Gramolini, Reading, MA (US)

(72) Inventor: Susan Gramolini, Reading, MA (US)

(21) Appl. No.: 19/422,402

(22) Filed: Dec. 16, 2025

Related U.S. Application Data
(60) Provisional application No. 63/734,715, filed on Dec. 16, 2024.

(51) Int. Cl. A01K 13/00

(52) U.S. Cl. CPC A01K 13/007

(57) ABSTRACT

Reusable and disposable dog paw cover sleeves for protecting canine paws from environmental hazards while preserving comfort, mobility, and natural sensory function. The sleeves are formed from durable, flexible materials such as nylon and include an adjustable loop or equivalent fastening system for secure retention on the dog's leg. A traction-enhancing base comprising rubber or elastomeric dots arranged in a paw-like pattern improves grip and simulates natural paw pad contact on various surfaces. Openings allow the dog's claws to remain exposed, maintaining balance and tactile feedback. The sleeves protect paws from extreme temperatures, sharp debris, unsanitary conditions, and pathogens, and are suitable for everyday use, recovery, or post-surgical care.

### CROSS-REFERENCE TO RELATED APPLICATION

This application claims the benefit of and priority to U.S. Provisional Patent Application No. 63/734,715, filed Dec. 16, 2025, the contents of all of which are incorporated herein by reference.

### FIELD OF THE INVENTION

The present invention relates generally to protective coverings for animal paws, and more particularly to reusable and disposable canine paw protection sleeves or mitts configured to provide traction, hygiene, environmental protection, and natural claw function.

### BACKGROUND OF INVENTION

Dogs are frequently exposed to environmental hazards such as hot pavement, snow and ice, sharp debris, allergens, and pathogens. These hazards pose risks to paw pad health, especially for pets recovering from injury, illness, or recent rescue. Traditional paw protection methods—including disposable booties and topical balms—fail to adequately address these risks while maintaining canine comfort and mobility.

Disposable dog booties often tear, slip off, or provide a poor fit, especially for active or differently sized breeds. Additionally, their use contributes to environmental waste. While paw balms provide moisturizing benefits, they do not protect against temperature extremes, sharp objects, or unsanitary conditions.

Reusable dog boots are a partial solution but are often rigid, ill-fitting, or fully enclose the paw, restricting the dog's claws and interfering with natural gait and sensory input. Dogs rely heavily on claw function for balance and traction, which makes traditional enclosed footwear problematic.

There is an unmet need for a durable, secure, hygienic, and comfortable solution —both reusable and disposable—that accommodates a range of paw sizes, claw structures, and activity levels. Such a solution should preserve the dog's natural movement and sensory engagement while offering real protection and being easy to apply and remove.

The present invention addresses these needs with a family of canine paw protection sleeves incorporating durable and flexible materials, integrated grip zones, open claw outlets, and layered designs. In some embodiments, the sleeves may accept medicated or absorbent inserts for post-operative care. Both reusable and disposable variants are disclosed, along with optional visibility features (e.g., translucent silicone or clear nylon) for inspection of wounds or foreign materials.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a disposable canine paw protection sleeve system comprising: a plurality of sleeves, each sleeve configured for placement on a paw of a canine; each sleeve comprising a substantially flat main body configured to wrap around a paw and a lower leg of the canine; a leg attachment loop coupled to the main body, the leg attachment loop being substantially circular in shape and configured to encircle the paw or lower leg; a layered construction comprising: (a) a base grip layer including a rubberized or textured traction material positioned to contact a ground surface, (b) a bendable support band positioned within the leg attachment loop and configured to be manually deformable while retaining structural shape, and (c) a comfort layer positioned between the paw and the base grip layer and configured for continuous contact with the paw; a fastening structure comprising a metal hook configured to engage a flexible loop to secure the sleeve around the paw; and one or more flexible claw loops positioned at a distal portion of the sleeve and configured to receive and guide protrusion of canine claws, wherein the sleeve provides traction, hygienic protection, and natural claw exposure while maintaining canine mobility.

The subject invention also discloses a reusable canine paw protection mitt system comprising: a plurality of reusable mitts, each mitt configured for placement over a paw and lower leg of a canine; each mitt comprising a substantially cylindrical main body formed from a durable and flexible textile material; a leg attachment strap coupled to the main body and configured to secure the mitt around the paw or lower leg; a layered construction of the main body comprising: (a) a base grip layer positioned on an underside of the mitt and including rubberized or textured traction material configured to contact a ground surface, (b) a support layer positioned above the base grip layer and configured to be deformable by hand while retaining structural shape to conform to the paw, and (c) a comfort layer positioned between the support layer and the paw and configured for continuous contact with the paw; a hook-and-loop fastener associated with the leg attachment strap for adjustable retention; and one or more double-layered woven mesh structures positioned at a distal portion of the mitt and configured to allow protrusion of canine claws, wherein the mitt provides traction, comfort, and protection while preserving natural claw function and mobility during repeated use.

In additional embodiments of the subject invention, a disposable canine paw protection sleeve comprises a substantially flat textile body configured to transition into a wrapped configuration around a canine paw and lower leg, the sleeve including a circular attachment loop reinforced with a manually bendable structural band, a ground-contacting traction layer formed from elastomeric material, an inner comfort layer formed from soft absorbent fabric, and a fastening interface comprising a metal hook engaging a flexible textile loop to maintain secure retention during ambulation. In additional embodiments of the subject invention, a canine paw protection article comprises a disposable wrap-around sleeve having a flat main body, a circular leg attachment loop, a rubberized traction base configured to contact the ground, a manually bendable structural band positioned within the attachment loop, and one or more claw-receiving loops that allow canine claws to protrude during use.

In embodiments of the subject invention, a canine paw protection system comprises a plurality of paw protection articles configured for placement on one or more paws of a canine, each article including a flexible body sized to wrap around a paw and lower leg, a traction-enhancing base layer configured to contact a ground surface, a support layer configured to provide structural conformity to paw anatomy, a comfort layer configured for continuous contact with the paw, a fastening mechanism configured to secure the article to the paw, and one or more claw exposure structures configured to allow natural protrusion of canine claws during use.

In embodiments of the subject invention, a canine paw protection system comprises a set of disposable paw sleeves formed from lightweight textile materials, each sleeve including a flat main body configurable into a wrapped shape, a circular leg attachment loop containing a manually bendable support band, a ground-contacting traction surface, a paw-facing comfort layer, and a fastening interface configured to secure the sleeve without adhesives.

In additional embodiments of the subject invention, a reusable canine paw protection system comprises a plurality of mitt-style paw coverings, each mitt having a cylindrical body, a proximal retention strap with hook-and-loop fastening, a layered sole including a traction layer, a deformable support layer, and a comfort layer, and a distal mesh structure configured to permit claw protrusion while maintaining mitt alignment.

In other embodiments of the subject invention, a modular canine paw protection system comprises both disposable sleeves and reusable mitts configured for interchangeable use depending on environmental conditions, duration of wear, or therapeutic needs, wherein each sleeve or mitt shares common functional elements including traction, structural conformity, comfort, and claw exposure.

In embodiments of the subject invention, a canine paw protection system further comprises optional inserts selected from absorbent pads, medicated dressings, or cushioning elements configured to be positioned within or beneath a comfort layer without interfering with traction or claw exposure.

In further embodiments of the subject invention, a method of protecting a canine paw comprises placing a flexible paw protection article around a paw and lower leg of a canine, shaping a support layer of the article to conform to the paw anatomy, securing the article using an adjustable fastening mechanism, allowing the canine's claws to protrude through designated openings, and permitting the canine to ambulate while maintaining traction, hygiene, and natural sensory function.

In other embodiments of the subject invention, a method of enhancing traction for a canine on indoor or outdoor surfaces comprises applying a paw protection sleeve or mitt having a textured traction base to one or more paws of the canine such that the traction base contacts the ground while the claws remain exposed to assist balance and stabilization.

In embodiments of the subject invention, a method of providing hygienic paw protection for a canine comprises positioning a disposable paw sleeve over a paw, securing the sleeve using a structural loop or strap, permitting claw protrusion through flexible openings, and removing and discarding the sleeve after use to reduce pathogen transfer.

In further embodiments of the subject invention, a method of supporting post-surgical or therapeutic recovery of a canine paw comprises applying a paw protection sleeve or mitt having a comfort layer and optional insert to the paw, allowing normal walking while shielding sensitive paw pads, and periodically removing or replacing the sleeve or insert as needed.

In additional embodiments of the subject invention, a method of maintaining canine mobility in extreme environmental conditions comprises selecting a paw protection article configured for temperature resistance, applying the article to the canine's paw, shaping a support layer to ensure secure retention, and permitting the canine to traverse hot, cold, wet, or abrasive surfaces.

In other embodiments of the subject invention, a method of preventing slippage of a paw protection article during canine movement comprises positioning a traction-enhancing base layer against the ground, aligning claw openings with the canine's claws, and securing the article with an adjustable fastening mechanism configured to maintain alignment during walking and turning.

In further embodiments of the subject invention, a disposable canine paw sleeve comprises a layered construction including a paw-contacting comfort layer, a traction-enhancing base layer, and an intermediate deformable support element that allows the sleeve to be shaped to the anatomical contours of a dog's paw and lower leg.

In other embodiments of the subject invention, a canine paw protector comprises a flexible textile body configured to wrap around a paw, a metal-reinforced fastening loop configured to secure the protector without adhesives, and traction structures arranged in a paw-pad-like pattern on a bottom surface.

In additional embodiments of the subject invention, a disposable paw sleeve includes a cotton or textile comfort layer that wraps around a bendable metal support band, thereby providing both cushioning and retention when the sleeve is secured to a canine paw.

In further embodiments of the subject invention, a paw protection device comprises a flat textile sheet configured to transition into a cylindrical configuration when wrapped around a paw, the device including integrated claw loops that guide natural claw extension while preventing material bunching.

In other embodiments of the subject invention, a canine paw sleeve comprises a traction base formed from elastomeric protrusions arranged to mimic natural paw pad pressure distribution, thereby maintaining canine gait stability across indoor and outdoor surfaces.

In additional embodiments of the subject invention, a disposable canine paw covering comprises a bendable structural band formed from metal or reinforced polymer material that retains shape during movement while allowing manual adjustment prior to application.

In further embodiments of the subject invention, a paw sleeve comprises a flexible hook-and-loop or hook-and-loop-equivalent fastening system integrated into a structural band, the fastening system being configured to maintain sleeve position during canine motion.

In other embodiments of the subject invention, a paw protector includes one or more elastic or mesh claw loops positioned at a distal end of the sleeve to preserve tactile feedback and traction provided by exposed claws.

In additional embodiments of the subject invention, a disposable canine paw sleeve is configured for veterinary, rescue, or post-operative use and provides a hygienic barrier against contaminants while allowing normal ambulation.

In further embodiments of the subject invention, a reusable canine paw mitt comprises a cylindrical textile body, a traction-enhancing base layer, a deformable internal support layer, and a soft comfort lining configured for repeated contact with the paw.

In other embodiments of the subject invention, a reusable paw mitt includes a hook-and-loop fastening strap positioned proximally on the mitt to secure the mitt around a canine's lower leg.

In additional embodiments of the subject invention, a reusable canine paw mitt comprises a double-layered woven mesh structure positioned at a distal end of the mitt and configured to allow claws to protrude without tearing or restriction.

In further embodiments of the subject invention, a reusable paw mitt includes a support layer formed from a bendable metal or shape-retentive polymer material configured to maintain mitt alignment during movement.

In other embodiments of the subject invention, a reusable paw mitt includes a comfort layer formed from cotton, fleece, microfiber, bamboo fabric, or padded textile material configured to minimize irritation during extended wear.

In additional embodiments of the subject invention, a canine paw mitt comprises layered materials selected to balance traction, breathability, washability, and durability for repeated indoor and outdoor use.

In further embodiments of the subject invention, a paw protection mitt includes antimicrobial-treated materials to reduce odor, infection risk, and pathogen transfer.

In other embodiments of the subject invention, a canine paw protector comprises a traction base configured to reduce slipping on smooth surfaces such as tile or hardwood flooring.

In additional embodiments of the subject invention, a paw sleeve or mitt comprises a deformable support layer that distributes load across the paw in a manner similar to natural paw pad contact.

In further embodiments of the subject invention, a canine paw protection article is configured to be provided as a matched set of four units corresponding to four paws.

In other embodiments of the subject invention, a paw sleeve comprises layered materials configured to resist moisture penetration while maintaining breathability.

In additional embodiments of the subject invention, a canine paw protector is configured to maintain consistent ground contact of a traction layer during walking, standing, and turning movements.

In further embodiments of the subject invention, a paw sleeve or mitt comprises adjustable fastening components allowing accommodation of different paw sizes and leg circumferences.

In other embodiments of the subject invention, a canine paw protection article is configured to preserve natural claw engagement with ground surfaces while shielding sensitive paw pads.

In additional embodiments of the subject invention, a paw sleeve or mitt is configured for temporary or long-term use depending on whether the materials are selected for disposable or reusable applications.

In additional embodiments of the subject invention, the traction-enhancing base layer is configured with zones of varying thickness to provide increased grip at high-pressure regions of the paw while maintaining flexibility at articulation points.

In further embodiments of the subject invention, the base grip layer includes a combination of raised traction elements and recessed channels to facilitate water drainage and reduce hydroplaning on wet surfaces.

In other embodiments of the subject invention, the bendable support layer is segmented into multiple sections to allow localized shaping around the paw and lower leg while maintaining overall structural integrity.

In additional embodiments of the subject invention, the support layer is encapsulated within a textile pocket to prevent direct contact between the structural material and the dog's skin.

In further embodiments of the subject invention, the comfort layer includes a moisture-wicking inner surface configured to draw moisture away from the paw during prolonged wear.

In other embodiments of the subject invention, the comfort layer includes a removable liner that can be replaced independently of the outer sleeve or mitt.

In additional embodiments of the subject invention, the sleeve or mitt includes reinforced stitching along high-stress regions to improve durability during repeated use.

In further embodiments of the subject invention, the fastening mechanism is positioned above the carpal joint to reduce rotational slippage during walking or running.

In other embodiments of the subject invention, the fastening mechanism includes elastic compliance to accommodate muscle expansion and contraction during movement.

In additional embodiments of the subject invention, the claw loop structures are reinforced with elastic binding to resist tearing caused by repeated claw engagement.

In further embodiments of the subject invention, the claw loop structures are asymmetrically arranged to align with the natural spacing of canine claws.

In other embodiments of the subject invention, the claw loop structures include individual openings for each claw to improve alignment and reduce twisting of the sleeve or mitt.

In additional embodiments of the subject invention, the sleeve or mitt includes a tactile alignment indicator to assist a user in correctly orienting the traction base relative to the paw.

In further embodiments of the subject invention, the traction elements are formed from heat-resistant elastomeric materials suitable for use on hot pavement.

In other embodiments of the subject invention, the traction elements are formed from cold-resistant materials configured to remain flexible in freezing conditions.

In additional embodiments of the subject invention, the sleeve or mitt includes antimicrobial treatments embedded within the comfort layer to reduce odor and bacterial growth.

In further embodiments of the subject invention, the sleeve or mitt includes antimicrobial treatments embedded within the traction layer to inhibit pathogen transfer from walking surfaces.

In other embodiments of the subject invention, the sleeve or mitt includes color-coding or visual markings to indicate size or paw position.

In additional embodiments of the subject invention, the sleeve or mitt includes reflective elements to enhance visibility in low-light environments.

In further embodiments of the subject invention, the sleeve or mitt is configured to be machine washable without degradation of traction or structural components.

In other embodiments of the subject invention, the sleeve or mitt is configured to be disposed of after a predetermined period of use for hygienic applications.

In additional embodiments of the subject invention, the layered construction is configured to provide thermal insulation for use in cold environments.

In further embodiments of the subject invention, the layered construction is configured to dissipate heat away from the paw for use in hot environments.

In other embodiments of the subject invention, the sleeve or mitt includes a smooth interior seam configuration to minimize friction against sensitive paw pads.

In additional embodiments of the subject invention, the sleeve or mitt includes stretch zones that allow expansion without loss of traction alignment.

In further embodiments of the subject invention, the sleeve or mitt includes reinforced edges around claw openings to prevent fraying during repeated use.

In other embodiments of the subject invention, the sleeve or mitt is configured to conform to left and right paw anatomy without requiring distinct left-or right-specific designs.

In additional embodiments of the subject invention, the sleeve or mitt is configured to accommodate minor bandaging or padding beneath the comfort layer.

In further embodiments of the subject invention, the sleeve or mitt maintains consistent ground contact of the traction base during standing, walking, and turning motions.

In embodiments of the subject invention, the sleeves or mitts may further include optional insert-receiving pockets or cavities configured to receive medicated pads, absorbent materials, gel inserts, or wound dressings, thereby enabling post-surgical treatment, injury protection, or therapeutic delivery without interfering with fit, traction, or claw exposure.

In other embodiments of the subject invention, the sleeves or mitts may be formed from translucent or semi-transparent materials, including clear nylon or translucent silicone, to allow visual inspection of the paw for wounds, foreign substances, bleeding, or moisture accumulation without removing the sleeve or mitt.

In further embodiments of the subject invention, the sleeves or mitts may include indicia, markings, or orientation guides indicating proper alignment of the traction base relative to the paw, thereby assisting users in correct application and reducing improper fit or rotation during use.

In additional embodiments of the subject invention, the sleeves or mitts may include reinforced seam structures positioned along high-stress regions, including around claw openings, fastener attachment points, or base grip transitions, to improve durability during vigorous activity or repeated use.

In other embodiments of the subject invention, the sleeves or mitts may include stretch zones or elasticized regions that accommodate muscle expansion, joint articulation, or paw flexion during walking, running, or standing while maintaining consistent retention.

In further embodiments of the subject invention, the sleeves or mitts may be configured to provide different traction densities or materials across different regions of the base grip layer, thereby increasing grip in high-load paw pad regions while preserving flexibility in articulation zones.

In additional embodiments of the subject invention, the sleeves or mitts may be configured to be reversible, allowing either side of the sleeve or mitt to be used as a ground-contacting surface depending on wear patterns or environmental conditions.

In further embodiments of the subject invention, the sleeves or mitts may be configured to be packaged as kits comprising multiple sizes, replacement liners, disposable variants, reusable variants, or cleaning instructions for veterinary, rescue, or consumer use.

In other embodiments of the subject invention, the sleeves or mitts may be configured for selective use on front paws, rear paws, or all four paws, with dimensional or structural differences optimized for differences in weight-bearing or gait mechanics between front and rear limbs.

In further embodiments of the subject invention, the sleeves or mitts may be configured to provide thermal insulation for cold environments or heat dissipation for hot environments by selectively modifying material thickness, layering order, or ventilation openings.

In additional embodiments of the subject invention, the sleeves or mitts may include odor-control treatments or deodorizing layers configured to reduce odor accumulation during extended wear.

In other embodiments of the subject invention, the sleeves or mitts may be configured to be applied without tools and removed rapidly in emergency situations, including veterinary or rescue scenarios.

In further embodiments of the subject invention, the sleeves or mitts may be configured to maintain consistent traction during transitions between different surface types, including transitions between indoor flooring and outdoor terrain.

In additional embodiments of the subject invention, the sleeves or mitts may be configured to maintain claw exposure sufficient to allow digging, scratching, or stabilization behaviors while still shielding sensitive paw pads.

In further embodiments of the subject invention, the sleeves or mitts may be configured to degrade or break away safely under excessive force to prevent injury or entanglement.

In other embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

### BRIEF DESCRIPTION OF THE DRAWINGS

Advantages of the present invention will be apparent from the following detailed description of embodiments, which description should be considered in conjunction with the accompanying drawings, in which:

FIG. 1 Illustrates an isometric view of a dog wearing a complete set of four disposable paw protection sleeves, showing how each sleeve fits securely around the dog's legs with front claw loops engaged and the base grip elements in contact with the ground.

FIG. 2 Illustrates a top isometric view of a single disposable paw protection sleeve, illustrating the looped closure band at the proximal end, dual claw loops at the distal end, and general cylindrical form.

FIG. 3 Illustrates a bottom isometric view of a single disposable paw protection sleeve, highlighting the arrangement of the traction-enhancing grip layer and the positioning of the comfort layer beneath the paw.

FIG. 4 Illustrates an exploded isometric view of a disposable paw protection sleeve, showing the layered construction including: a top fabric loop with metal connection band, a middle bendable metal support band, a lower cotton comfort layer, and a base grip layer with rubberized or textured material.

FIG. 5 Illustrates an isometric view of a dog wearing a complete set of four reusable paw protection mitts, illustrating secure Hook and loop fastening, visible mesh claw outlets, and structured base layers.

FIG. 6 Illustrates a bottom isometric view of a single reusable paw protection mitt, showing the Hook and loop closure loop and woven mesh openings at the front for claw

passage.

FIG. 7 Illustrates a top view of a single reusable paw protection mitt in the closed configuration.

FIG. 8 Illustrates an exploded isometric view of a reusable paw protection mitt, depicting the multi-layer structure including: a top polyester outer sleeve with Hook and loop closure, a bendable metal support band, a breathable polyester comfort liner, a heat-resistant grip outsole, and a front double-layered woven mesh section for claw exposure.

### DESCRIPTION OF THE INVENTION

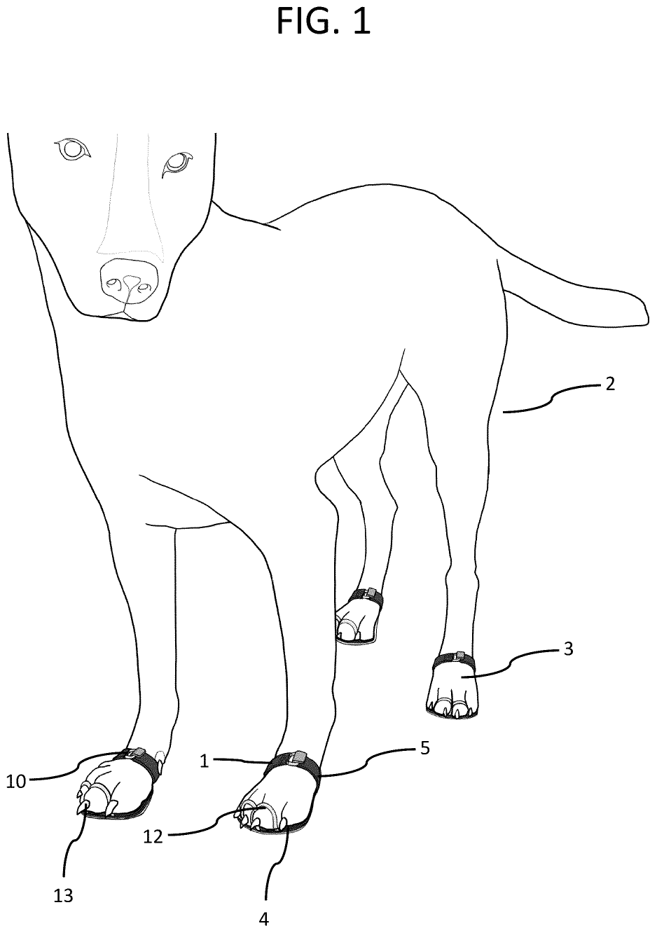

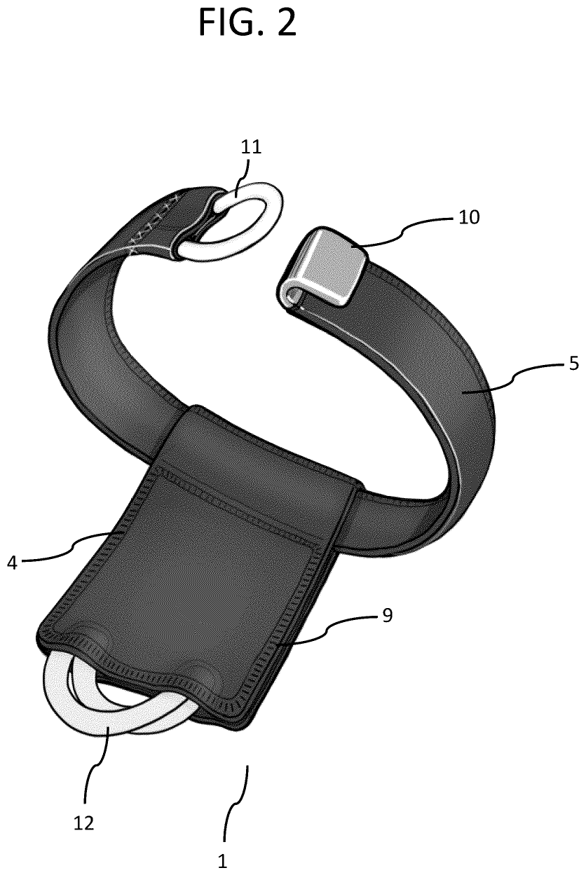

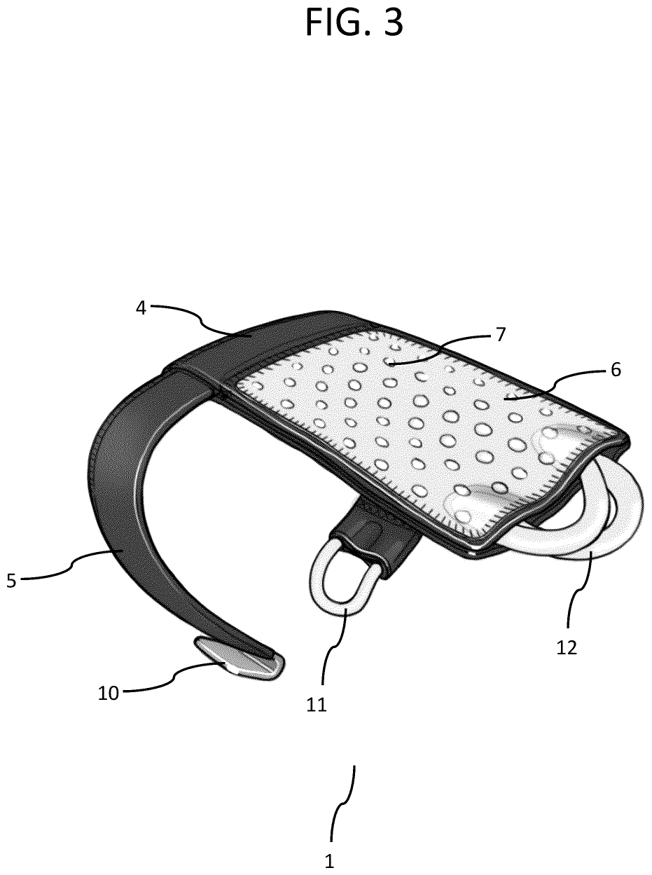

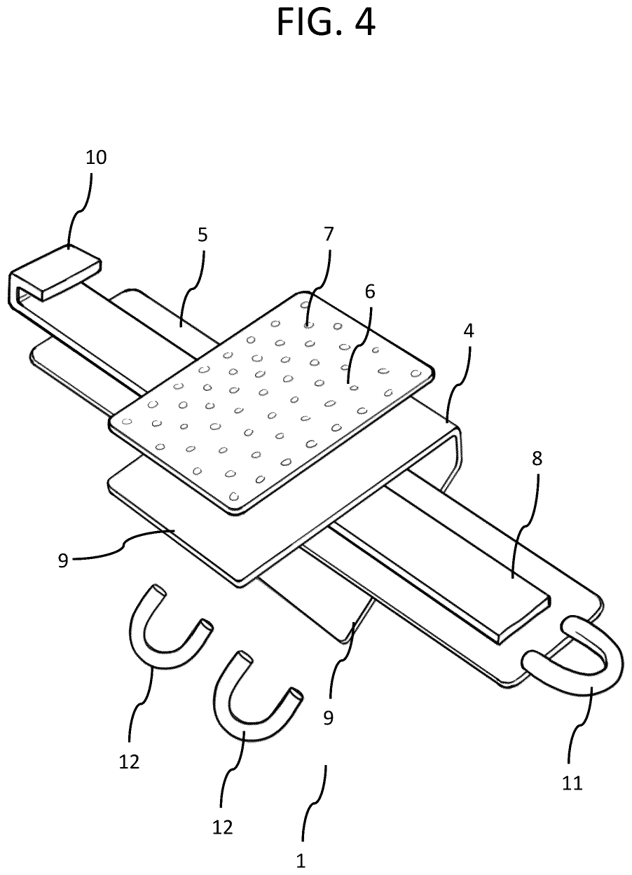

As illustrated in FIGS. 1-4, the first embodiment of the subject invention comprises a set of four disposable sleeves 1, one for each canine's 2 paw 3, made from durable and flexible materials such as nylon, polyester, or other synthetic fabric. This material may be lightweight, breathable, and resistant to wear and tear, ensuring long-lasting performance even during high-activity use. Each disposable sleeve 1 is designed to comfortably wrap around a dog 2's paw 3 and lower leg.

Each disposable sleeve 1 has a main body 4 that is substantially flat in shape with a leg attachment loop 5 that is substantially circular in shape. The main body 4 of each disposable sleeve 1 comprises a layered construction including: a base grip layer 6 with rubberized or textured material 7, a bendable metal support band 8 within the leg attachment loop 5, and a top cotton comfort layer 9. In embodiments of the subject invention, the cotton comfort layer 9 may wrap around the leg attachment loop 5 and the metal support band 8. The leg attachment loop 5 comprises a metal connection hook 10 for attaching around the paw 3 to a flexible loop 11 on the opposing end of loop 5 preventing slippage during movement while maintaining a snug and comfortable fit. In embodiments of the subject invention, the hook 10 may be formed as part of the metal support band 8. Each disposable sleeve 1 comprises one or more flexible claw loops 12 for looping around the canine's 2 claws 13.

In embodiments of the subject invention, the rubberized or textured material 7 of the base grip layer 6 of the sleeves 1 may be any suitable traction-enhancing structure, including but not limited to: rubber adhesive dots, elastomeric pads, silicone nodes, thermoplastic rubber elements, raised ridges, patterned treads, hexagonal or circular protrusions, linear grip ribs, paw-pad-shaped traction zones, micro-textured surfaces, or combinations thereof, which may be arranged in a paw-like pattern or other functional configurations. These elements provide additional traction on various surfaces, such as hardwood floors, tile, snow, ice, wet pavement, grass, carpet, or rough outdoor terrain, thereby reducing the risk of slipping. The paw-like pattern mimics the natural distribution of pressure on a dog's paw, helping to preserve natural gait mechanics, balance, and movement while maintaining consistent ground contact during use.

In embodiments of the subject invention, the bendable metal support band 8 may be formed from any suitable metal or structural material that is deformable by hand while still providing sufficient structural support and shape retention, including, but not limited to: aluminum, aluminum alloys, stainless steel, spring steel, mild steel, copper, brass, bronze, tin, nickel alloys, malleable iron, or layered or laminated metal composites. In some embodiments, the support band may alternatively be formed from non-metallic yet bendable structural materials, such as reinforced polymers, shape-memory alloys, elastomeric composites, flexible thermoplastics, or embedded wire or mesh structures. The bendable support band may be configured to conform to the anatomical contours of the dog's paw and lower leg, maintain sleeve positioning during movement, and improve load distribution without creating pressure points or restricting natural motion.

In embodiments of the subject invention, the cotton support layer 9 may be formed from a suitable soft material that is resilient yet comfortable for constant contact against the dog's paw, including, but not limited to: natural cotton, organic cotton, cotton blends, flannel, fleece, terry cloth, microfiber textiles, bamboo fabric, modal fabric, soft polyester knits, memory foam layers, gel-infused fabrics, neoprene-lined textiles, or padded non-woven materials. Such materials may be selected to provide cushioning, moisture absorption, breathability, and thermal comfort while minimizing friction or irritation to sensitive paw pads. In certain embodiments, the support layer may further include antimicrobial treatments, moisture-wicking properties, or replaceable liners to enhance hygiene, durability, and suitability for extended wear or post-surgical recovery.

In embodiments of the subject invention, the flexible claw loops 12 allow the dog's claws 13 to protrude from the enclosed sleeves 1, thereby preserving the dog's natural sensory functions, balance, and traction while maintaining comfort during use. Some embodiments use individual or paired claw loops formed from elastic, mesh, fabric, or

reinforced textile materials to guide natural claw extension and positioning without pinching or restricting movement. The claw loop structure may be sized or stretchable to accommodate different claw lengths and shapes and may be reinforced to resist tearing during repeated use. In certain embodiments, the claw loops may also reduce bunching of the sleeve material at the distal end, promote proper alignment of the sleeve during motion, and help maintain consistent contact between the base grip layer and the ground surface.

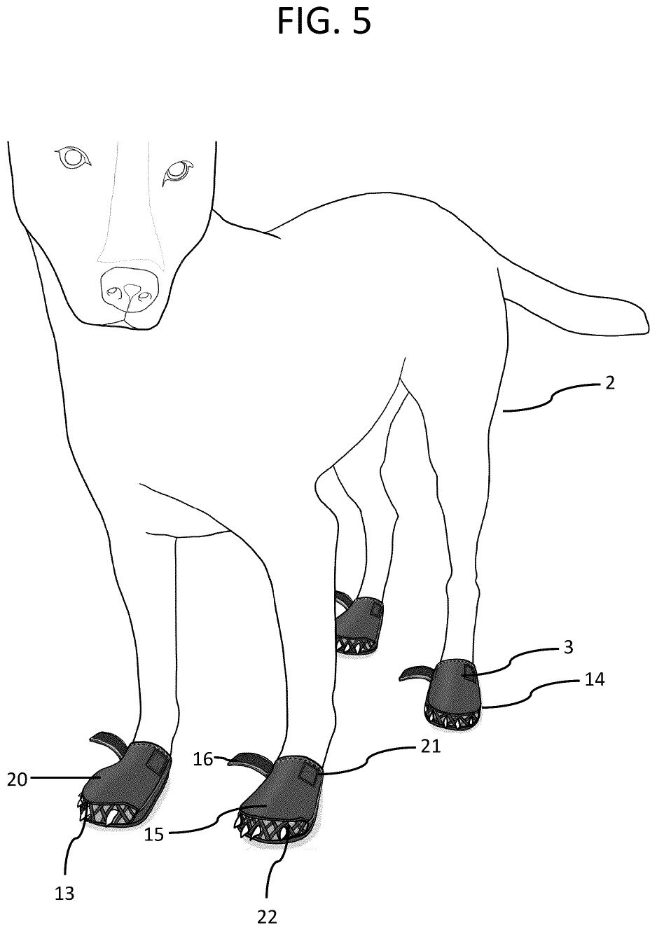

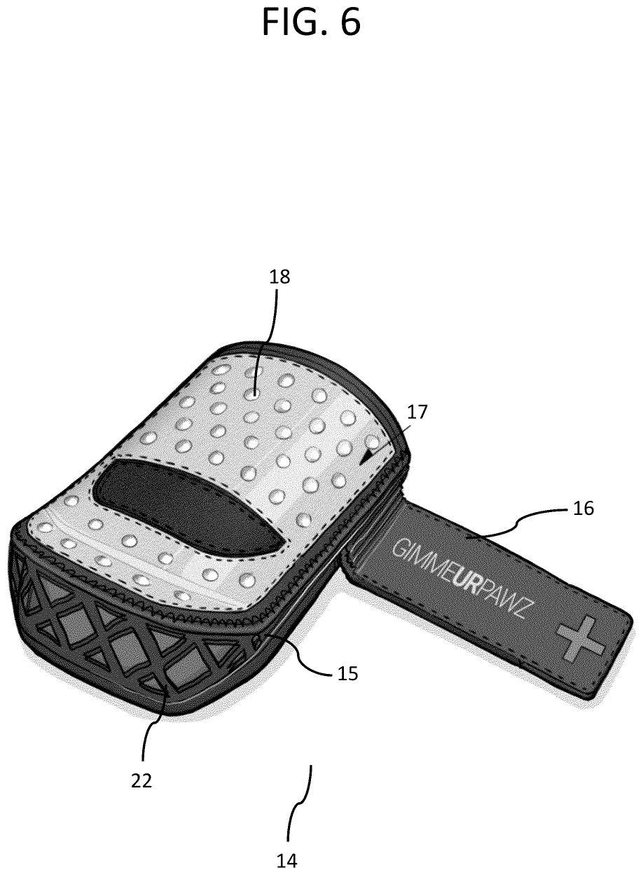

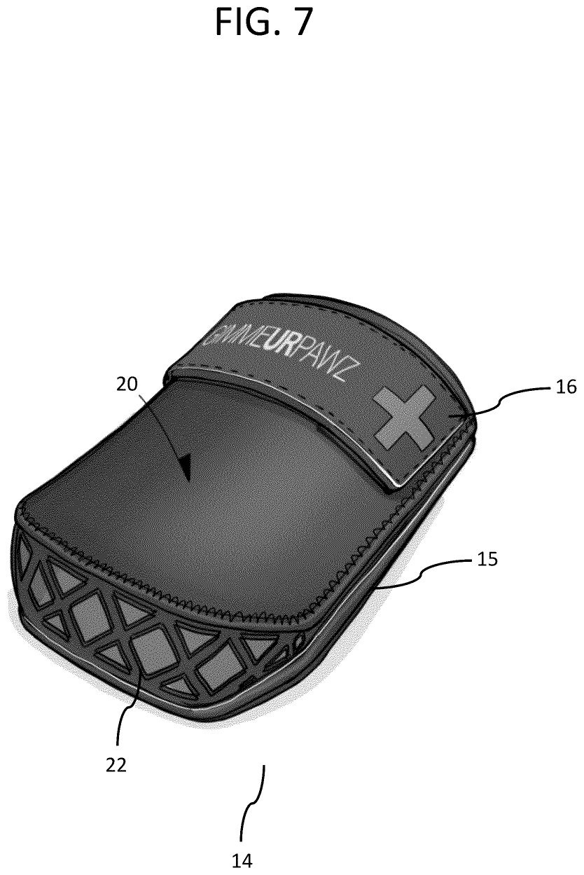

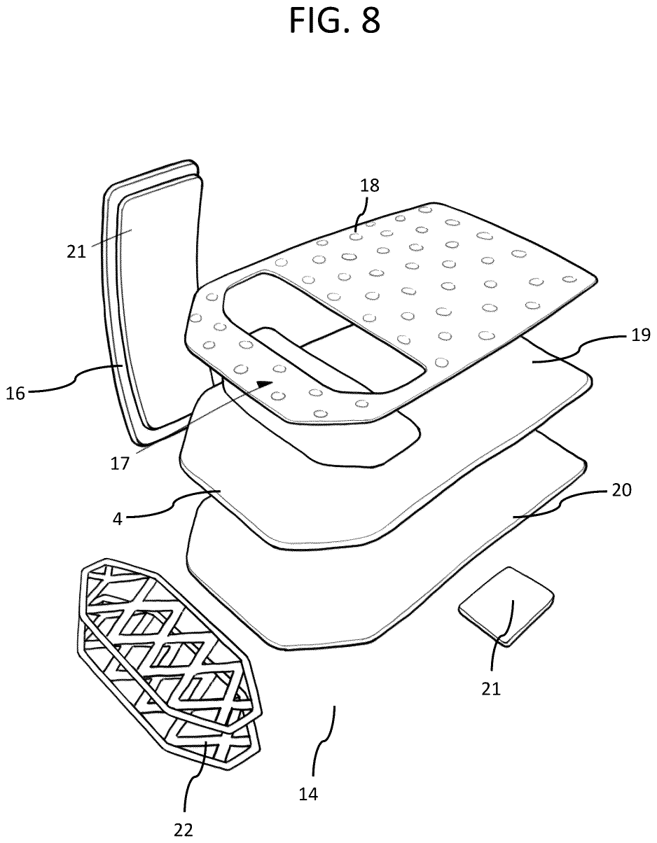

As illustrated in FIGS. 5-8, the second embodiment of the subject invention comprises a set of four reuseable mitts 14, one for each canine's 2 paw 3, made from durable and flexible materials such as nylon, polyester, or other synthetic fabric. This material may be lightweight, breathable, and resistant to wear and tear, ensuring long-lasting performance even during high-activity use. Each reuseable mitt 14 is designed to comfortably wrap around a dog 2's paw 3 and lower leg.

Each reuseable mitts 14 has a main body 15 that is substantially cylindrical in shape with a leg attachment strap 16. The main body 15 of each reuseable mitt 14 comprises a layered construction including: a base grip layer 17 with rubberized or textured material 18, a support layer 19, and a top comfort layer 20. The leg attachment strap 16 comprises a hook and loop fastener 21 for attaching around the paw 3 preventing slippage during movement while maintaining a snug and comfortable fit.

Each reuseable mitt 14 comprises one or more flexible double layered weaved fishnets 22 for looping around the canine's 2 claws 13.

In embodiments of the subject invention, the rubberized or textured material 18 of the base grip layer 17 of the reuseable mitts 14 may be any suitable traction-enhancing structure, including but not limited to: rubber adhesive dots, elastomeric pads, silicone nodes, thermoplastic rubber elements, raised ridges, patterned treads, hexagonal or circular protrusions, linear grip ribs, paw-pad-shaped traction zones, micro-textured surfaces, or combinations thereof, which may be arranged in a paw-like pattern or other functional configurations. These elements provide additional traction on various surfaces, such as hardwood floors, tile, snow, ice, wet pavement, grass, carpet, or rough outdoor terrain, thereby reducing the risk of slipping. The paw-like pattern mimics the natural distribution of pressure on a dog's paw, helping to preserve natural gait mechanics, balance, and movement while maintaining consistent ground contact during use.

In embodiments of the subject invention, the support layer 19 may be formed from any suitable metal or structural material that is deformable by hand while still providing sufficient structural support and shape retention, including, but not limited to: aluminum, aluminum alloys, stainless steel, spring steel, mild steel, copper, brass, bronze, tin, nickel alloys, malleable iron, or layered or laminated metal composites. In some embodiments, the support band may alternatively be formed from non-metallic yet bendable structural materials, such as reinforced polymers, shape-memory alloys, elastomeric composites, flexible thermoplastics, or embedded wire or mesh structures. The bendable support band may be configured to conform to the anatomical contours of the dog's paw and lower leg, maintain mitts positioning during movement, and improve load distribution without creating pressure points or restricting natural motion.

In embodiments of the subject invention, the comfort layer 20 may be formed from a suitable soft material that is resilient yet comfortable for constant contact against the dog's paw, including, but not limited to: natural cotton, organic cotton, cotton blends, flannel, fleece, terry cloth, microfiber textiles, bamboo fabric, modal fabric, soft polyester knits, memory foam layers, gel-infused fabrics, neoprene-lined textiles, or padded non-woven materials. Such materials may be selected to provide cushioning, moisture absorption, breathability, and thermal comfort while minimizing friction or irritation to sensitive paw pads. In certain embodiments, the support layer may further include antimicrobial treatments, moisture-wicking properties, or replaceable liners to enhance hygiene, durability, and suitability for extended wear or post-surgical recovery.

In embodiments of the subject invention, the double layered weaved fishnets 22 allow the dog's claws 13 to protrude from the enclosed reuseable mitts 14, thereby preserving the dog's natural sensory functions, balance, and traction while maintaining comfort during use. Some embodiments use individual or paired claw loops formed from elastic, mesh, fabric, or reinforced textile materials to guide natural claw extension and positioning without pinching or restricting movement. The claw loop structure may be sized or stretchable to accommodate different claw lengths and shapes and may be reinforced to resist tearing during repeated use. In certain embodiments, the claw loops may also reduce bunching of the mitt material at the distal end, promote proper alignment of the mitts during motion, and help maintain consistent contact between the base grip layer and the ground surface.

In embodiments of the subject invention, the sleeves or mitts may be composed of lightweight, breathable, and resistant fabrics, including, but not limited to: nylon, polyester, woven or non-woven synthetic textiles, microfiber fabrics, elastomeric blends, mesh or fishnet fabrics, silicone-coated textiles, thermoplastic polyurethane (TPU) laminates, neoprene, spandex or Lycra® blends, polyurethane-coated fabrics, waterproof or water-resistant technical fabrics, antimicrobial or treated textiles, and combinations thereof. Such materials may be selected to balance durability, flexibility, breathability, washability, and comfort, while withstanding repeated use, environmental exposure, and cleaning cycles. In some embodiments, the fabrics may be layered or laminated to provide enhanced performance characteristics, such as moisture resistance, thermal insulation, traction support, or antimicrobial properties, depending on whether the sleeve or mitt is configured for reusable or disposable use, indoor or outdoor environments, or therapeutic and post-surgical applications.

In embodiments of the subject invention, the sleeves or mitts may be treated with antimicrobials, such as silver-based compounds, copper-based compounds, zinc-based additives, quaternary ammonium compounds, chitosan, triclosan alternatives, or plant-derived antimicrobial agents, to inhibit the growth of bacteria, fungi, and other microorganisms. Such antimicrobial treatments may be incorporated into the fabric fibers, applied as surface coatings, or embedded within one or more layers of the sleeve material. In certain embodiments, the antimicrobial treatment may be configured to withstand repeated washing or environmental exposure, making the sleeves suitable for extended reuse, veterinary settings, rescue operations, or post-surgical care. These treatments may reduce odor, minimize infection risk, and improve hygiene when the sleeves or mitts are used in unsanitary environments or in contact with open wounds or sensitive paw tissue.

In embodiments of the subject invention, the sleeves or mitts may be any suitable shape to comfortably wrap around a dog's paw, including, but not limited to cylindrical shapes, tapered tubular shapes, contoured or anatomically shaped sleeves, mitt enclosures, partially open-ended sleeves, wrap-around configurations, segmented or articulated forms, and hybrid shapes combining rigid and flexible regions. The selected shape may vary based on paw size, breed, activity level, or intended use, such as everyday walking, indoor traction, outdoor protection, or post-operative recovery. In some embodiments, the sleeve geometry may be configured to conform to the natural curvature of the paw and lower leg, reduce bunching or pressure points, and allow natural claw extension, while still providing secure retention and consistent contact between the grip surface and the ground.

In embodiments of the subject invention, the sleeves or mitts may have a suitable fastener, including but not limited to hook-and-loop fasteners (Velcro®), elastic bands, stretchable fabric cuffs, TheraBand® or similar elastic wraps, snap fasteners, buttons, buckles, adjustable straps, twist-tie style closures, drawstrings, magnetic fasteners, adhesive tabs, or combinations thereof. The fastener may be positioned at a proximal end of the sleeve or integrated along a wrap-around portion to secure the sleeve or mitt to the dog's paw without restricting circulation or natural movement. In certain embodiments, the fastener may be adjustable to accommodate different paw and leg sizes, easy to engage and disengage with one hand, and configured to remain secure during vigorous activity while allowing rapid removal when needed, such as during veterinary treatment or cleaning.

While several variations of the present invention have been illustrated by way of example in particular embodiments, it is apparent that further embodiments could be developed within the spirit and scope of the present invention. However, it is to be expressly understood that such modifications and adaptations are within the spirit and scope of the present invention, and are inclusive, but not limited to the following appended claims as set forth.

1. A disposable canine paw protection sleeve system comprising:
a plurality of sleeves, each sleeve configured for placement on a paw of a canine;
each sleeve comprising a substantially flat main body configured to wrap around a paw and a lower leg of the canine;
a leg attachment loop coupled to the main body, the leg attachment loop being substantially circular in shape and configured to encircle the paw or lower leg;
a layered construction comprising:
(a) a base grip layer including a rubberized or textured traction material positioned to contact a ground surface,
(b) a bendable support band positioned within the leg attachment loop and configured to be manually deformable while retaining structural shape, and
(c) a comfort layer positioned between the paw and the base grip layer and configured for continuous contact with the paw;
a fastening structure comprising a metal hook configured to engage a flexible loop to secure the sleeve around the paw; and
one or more flexible claw loops positioned at a distal portion of the sleeve and configured to receive and guide protrusion of canine claws,
wherein the sleeve provides traction, hygienic protection, and natural claw exposure while maintaining canine mobility.

2. The system of claim 1, wherein the base grip layer comprises rubber adhesive dots arranged in a paw-like pattern.

3. The system of claim 1, wherein the bendable support band is formed from aluminum alloy.

4. The system of claim 1, wherein the comfort layer comprises cotton or a cotton-based textile.

5. The system of claim 1, wherein the fastening structure is formed integrally with the bendable support band.

6. The system of claim 1, wherein the claw loops comprise elastic or mesh material.

7. The system of claim 1, wherein the sleeves are sized for single-use disposal.

8. The system of claim 1, wherein the layered construction resists penetration of moisture or pathogens.

9. The system of claim 1, wherein the sleeves are provided as a set of four sleeves corresponding to four canine paws.

10. The system of claim 1, wherein the claw loops reduce bunching of the main body during canine movement.

11. A reusable canine paw protection mitt system comprising:
a plurality of reusable mitts, each mitt configured for placement over a paw and lower leg of a canine;
each mitt comprising a substantially cylindrical main body formed from a durable and flexible textile material;
a leg attachment strap coupled to the main body and configured to secure the mitt around the paw or lower leg;
a layered construction of the main body comprising:
(a) a base grip layer positioned on an underside of the mitt and including rubberized or textured traction material configured to contact a ground surface,
(b) a support layer positioned above the base grip layer and configured to be deformable by hand while retaining structural shape to conform to the paw, and
(c) a comfort layer positioned between the support layer and the paw and configured for continuous contact with the paw;
a hook-and-loop fastener associated with the leg attachment strap for adjustable retention; and
one or more double-layered woven mesh structures positioned at a distal portion of the mitt and configured to allow protrusion of canine claws,
wherein the mitt provides traction, comfort, and protection while preserving natural claw function and mobility during repeated use.

12. The system of claim 11, wherein the base grip layer comprises rubber adhesive dots arranged in a paw-like pattern.

13. The system of claim 11, wherein the support layer comprises a bendable metal selected from aluminum, stainless steel, or a metal alloy.

14. The system of claim 11, wherein the support layer comprises a non-metallic bendable material selected from reinforced polymers, shape-memory alloys, or elastomeric composites.

15. The system of claim 11, wherein the comfort layer comprises cotton, fleece, microfiber, bamboo fabric, or a padded non-woven textile.

16. The system of claim 11, wherein the comfort layer includes antimicrobial or moisture-wicking treatments.

17. The system of claim 11, wherein the double-layered woven mesh structures comprise elastic or reinforced textile fishnet material.

18. The system of claim 11, wherein the mesh structures reduce bunching of the mitt at a distal end during canine movement.

19. The system of claim 11, wherein the mitts are machine washable and configured for repeated indoor and outdoor use.

20. The system of claim 11, wherein the plurality of reusable mitts comprises four mitts corresponding to four canine paws.
